(19) United States
(12) Patent Application Publication
(10) Pub. No.: US 2007/0289631 A1
(43) Pub. Date: Dec. 20, 2007

(54) FUSIBLE LINK VALVE

(75) Inventors: Scott Higgins, Ozark, MO (US); Clark Holden, Springfield, MO (US)

Correspondence Address: HOVEY WILLIAMS LLP, 2405 GRAND BLVD., SUITE 400, KANSAS CITY, MO, 64108, US

(73) Assignee: Custom Metalcraft, Inc., Springfield, MO (US)

(21) Appl. No.: 11/751,419

(22) Filed: May 21, 2007

Related U.S. Application Data
(60) Provisional application No. 60/804,813, filed on Jun. 14, 2006.

(51) Int. Cl. F16K 17/38; F16K 31/64

(52) U.S. Cl. 137/75; 137/79; 251/116; 251/315.01

(57) ABSTRACT

An improved outlet valve assembly (12) is provided which is especially adapted for use with an intermediate bulk container (10) having bottom wall drain outlet (20) and support legs (22). The assembly (12) has serially interconnected valves (28,30), namely an emergency ball valve (28) and a manually operable valve (30), with endmost elbow coupler (26) and outlet (32). Tle assembly (12) is of compact design and is dimensioned to permit attachment to container (10) with the entirety of assembly (12) elevated above the bottom of support legs (22). The emergency ball (28) valve includes as spring-loaded operator (58) equipped with a temperature responsive fusible link (86). In the event of a fire adjacent container (10), the link (86) severs, allowing operator (58) to quickly close valve (28).

### CROSS-REFERENCE TO RELATED APPLICATION

This application claims the benefit of U.S. Provisional Application No. 60/804,813, Filed Jun. 14, 2006. This Provisional Application is also incorporated by reference herein.

### BACKGROUND OF THE INVENTION

1. Field of the Invention

The present invention is broadly concerned with improved outlet valve assemblies having ball-type emergency valves which are specifically designed for use with intermediate bulk containers (IBCs). The emergency valves operate and provide quick closure upon experiencing an emergency condition such as elevated temperatures indicative of a fire adjacent the IBC. More particularly, the invention is concerned with such outlet valve assemblies including serially interconnected manual and emergency ball valves of compact, robust design and sized to fit beneath standard IBCs while providing adequate ground clearance.

2. Description of the Prior Art

Intermediate bulk containers are an important class of tanks used for the transport and storage of corrosive or valuable liquids. As such, IBCs are formed of metal (e.g., stainless steel) and have a bottom wall, upstanding sidewall structure, and a top wall equipped with an fill opening. The bottom wall has a drain outlet strategically located near a corner thereof to assure proper drainage of the tank. Additionally, the containers are supported by corner-mounted legs which elevate the bottom wall and allow the containers to be moved by conventional forklifts.

All IBCs further include an outlet valve secured to the drain outlet so as to permit controlled drainage. It is important that such drains be sized so as not to interfere with forklift movement of the containers and to otherwise afford adequate ground clearance between the outlet valve and the bases of the support legs.

In situations where IBCs are used to transport and store highly flammable liquids, it is desirable that the IBCs have emergency drain closure apparatus to rapidly close the drain opening in the event of a fire adjacent the container. As can be appreciated, in the absence of such a safety feature, continued drainage of flammable fluids from the container can continually feed such a fire and lead to a catastrophic conflagration.

IBC manufacturers have responded to these safety concerns by attempting to equip their IBCs with off-the-shelf emergency, temperature-responsive valves. These conventional valves are generally not suited for use with an IBC. For example, many such valves are flapper- or plunger-type valves which do not have sufficiently robust constructions to withstand the normal shocks and rough handling commonly experienced with IBCs. Further, many of these prior valves are designed to close under shock loads which would be inappropriate for IBCs. Finally, many presently available emergency valves are not compact enough to fit beneath an IBC while still providing necessary ground clearance.

U.S. Pat. No. 3,396,739 describes a plunger-type emergency valve which is responsive to impact, jarring, or heat. The valve is spring-biased towards the seat and is normally held in an open condition by a dual-spring emergency-sensitive mechanism. The valve of the '739 patent are used with fuel dispensing pumps in filling stations, but would not be suitable for IBCs.

U.S. Pat. No. 4,099,551 also describes a thermally-responsive butterfly valve which can trip upon experiencing vibrational shocks. The valve is equipped with a manual operation cord which could not withstand the drop testing or rugged handling conditions common with IBCs. U.S. Pat. No. 6,105,597 discloses a very complex emergency shut-off valve of butterfly design. Again, owing to the many mechanisms associated with this valve, it would not withstand IBC handling over extended time periods. Moreover, the design requires mechanism extending beyond the underside of an IBC, which would be wholly unsuitable.

Additional references describing emergency valves include U.S. Pat. Nos. 1,918,728; 2,004,717; 2,013,510; 4,468,194; and 4,746,034.

A further problem with essentially all of these prior emergency valves is that they would be very difficult if not impossible to retrofit onto existing IBCs

### SUMMARY OF THE INVENTION

The present invention overcomes the problems outlined above and provides outlet valve assemblies and emergency outlet ball valves of robust, compact design which are specifically designed for use with IBCs and are able to withstand the rugged conditions of use encountered with IBCs. Broadly speaking, the emergency ball valves of the invention include a valve body, a rotatable valve ball in the body having an outwardly extending stem, and an emergency condition operator coupled with the valve stem and operable to quickly move the valve ball from the valve-open position to valve-closed position in response to the occurrence of an emergency condition. The preferred emergency valves are temperature-responsive, and include a handle secured to the valve stein operable to move the ball to the valve-open to the valve-closed position thereof, together with a spring engaging the handle and biasing it towards the valve-closed position. A link is coupled with the handle and is operable to maintain the handle in the valve-open position against the bias of the spring. However, the link is operable to sever in the event of the emergency condition to permit the spring to move the ball valve to the valve-closed position. Preferably, the link is temperature-responsive, and severs upon experiencing a predetermined elevated temperature consistent with a fire adjacent the protected container.

The outlet valve assemblies of the invention are designed for attachment to the outlet of an intermediate bulk container and comprise a manually operable valve shiftable between a valve-open position permitting flow of liquid therethrough and a valve-closed position preventing such liquid flow, together with an emergency ball valve of the type described above, in series with the manually operable valve. Such assemblies are preferably of in-line design to allow normal draining of an IBC by manipulation of the manually operable valve, while also affording an emergency closure function in the event of a fire or the like.

### BRIEF DESCRIPTION OF THE DRAWINGS

FIG. 1 is a bottom perspective view of an IBC tank equipped with an outlet valve assembly in accordance with the invention;

FIG. 2 is a fragmentary side view of the tank of FIG. 1 resting on a support surface, and illustrating the construction of the outlet valve assembly;

FIG. 3 is a fragmentary bottom view of the tank of FIG. 1, illustrating the construction of the outlet valve assembly;

FIG. 4 is a fragmentary perspective view of the tank of FIG. 1, illustrating the construction of the outlet valve assembly, with the emergency valve in its open position;

FIG. 5 is a view similar to that of FIG. 4, showing the emergency valve in its closed position;

FIG. 6 is a fragmentary side view similar to that of FIG. 2, but showing the emergency valve in its closed position; and

FIG. 7 is a an exploded perspective view partially in section and depicting the construction of the emergency valve forming a part of the outlet valve assembly.

### DETAILED DESCRIPTION OF THE PREFERRED EMBODIMENT

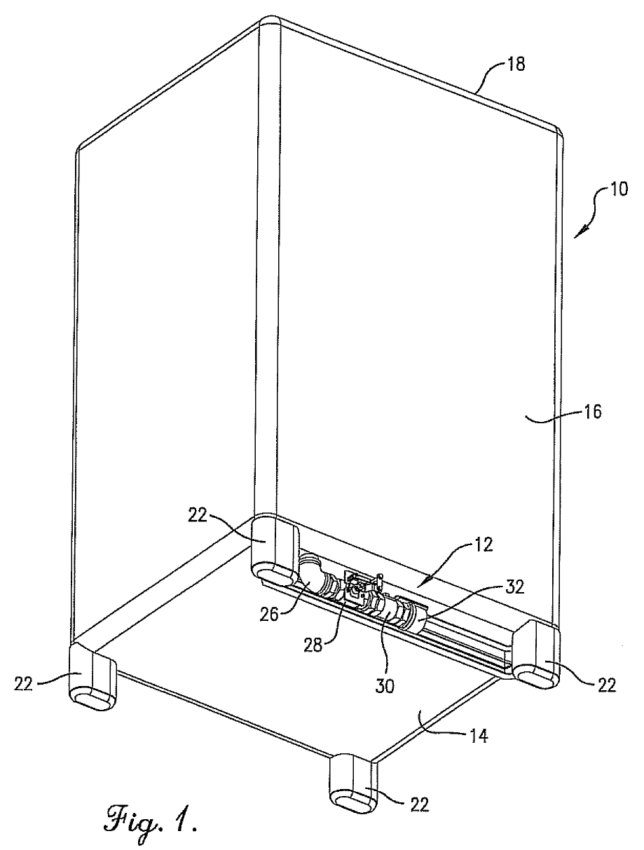

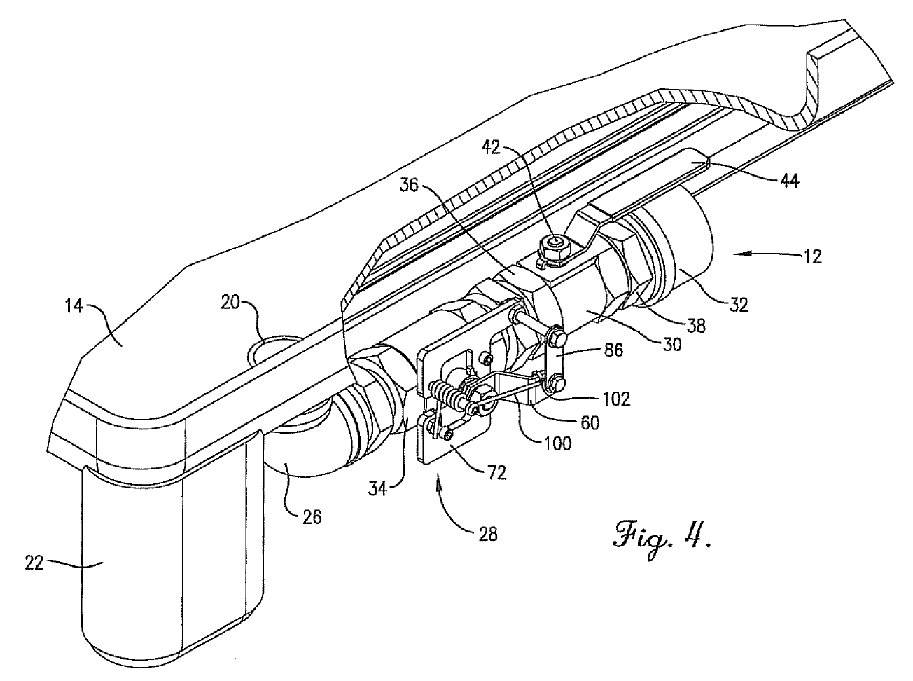

Turning now to the drawings, an intermediate bulk container 10 is illustrated in FIG. 1, and is equipped with an outlet valve assembly 12 in accordance with the invention. The container 10 is itself conventional and has a bottom wall 14, interconnected, upstanding sidewall structure 16, and a top wall 18. The bottom wall 14 includes a marginal drain outlet opening 20 (FIG. 4). The tank further has four corner-mounted legs 22 adapted to rest upon a support surface 24 in order to elevate the bottom wall 14 above the latter. The container 10 is typically fabricated from stainless steel or other chemical-resistant material, and is designed for transference and storage of corrosive or valuable liquids.

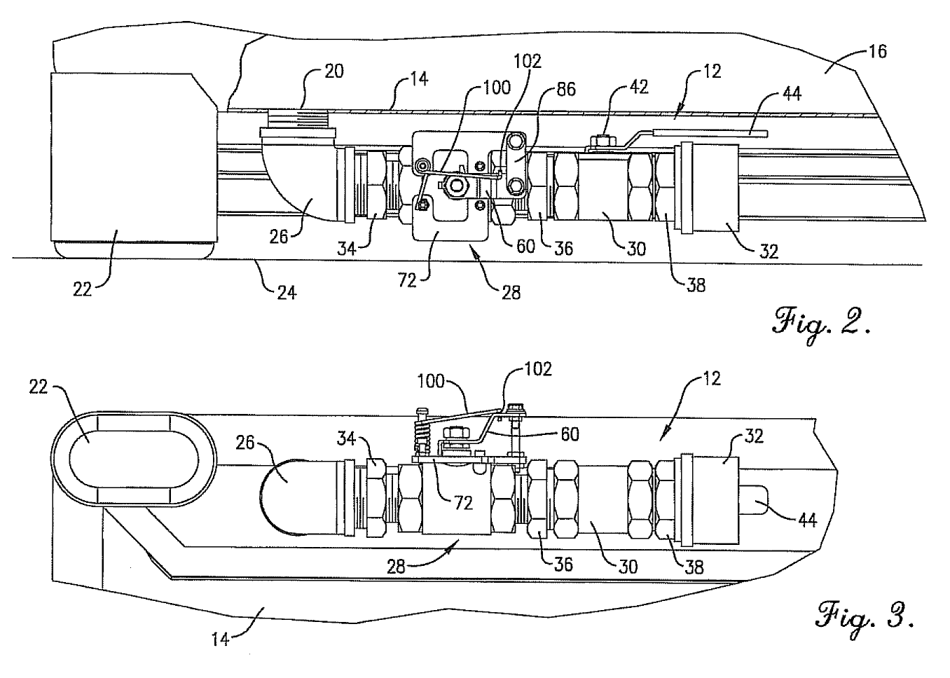

The outlet valve assembly 12 is designed for attachment to bottom wall 14 of the container 10, and specifically to the outlet opening 20, in order to allow controlled drainage of the container 10, while also providing a rapid closure function in the event of an emergency, and especially a fire adjacent the container 10. Importantly, the assembly 12 is of in-line construction and has a minimal height, so that the entire assembly 12 is situated above a support surface 24 as best seen in FIG. 2.

Specifically, the assembly 12 includes from left to right as viewed in the Figures, a threaded inlet elbow 26 having attachment nipple 27, an emergency ball valve 28, a manually operable valve 30, and a fluid outlet 32. As illustrated, the components 26-32 are threadably connected together using threaded nipples 33, bushings 34,36, as well as quick disconnect coupler 38 (see FIG. 7).

The preferred manual valve 30 is entirely conventional and is in the form of a ball valve having valve body 40 housing a rotatable valve ball (not shown), the latter having a stem 42 extending through the body 40. A manual operating handle 44 is secured to stem 42 and allows selective manual operation of valve 30 between a valve-open position shown in the Figures and a valve-closed position preventing the flow of liquid therethrough. The outlet 32 is also conventional and is a tubular element quick-coupled to the outlet of body 40 via coupler 38.

The emergency ball valve 28 has a tubular body 46 with internally threaded input and output ends 48 and 50, and an intermediate stem opening 51. A valve ball 52 is located within body 46 and has a liquid through-passage 54 as well as an externally threaded valve stem 56 extending through opening 51. As will be readily understood, the ball 52 is selectively rotatable by rotation of stem 56 between a normal valve-open position shown in FIG. 7 to a valve-closed position wherein the passage 54 is out of communication with the ends 48 and 50 to thereby prevent flow of liquid through the valve 28.

The valve 28 also has an emergency condition operator 58 designed to close the valve in response to the occurrence of an emergency condition. The operator 58 includes a generally L-shaped handle 60 having a slot 62 receiving the outer end of stem 56, with the handle 60 secured to stem 56 by way of washer 64 and nut 66. As illustrated, the outboard flange 68 of handle 60 has a connector opening 70 therethrough. The operator 58 also has an apertured plate 72 secured to body 46 by means of attachment screws 74. The plate 72 has an upper coil spring mount 76 as well as a lower spring arm retainer 78. Additionally, the plate 72 includes a projecting flange 80 supporting an elongated link mount 82, secured by connectors 84. The mount 82 supports a depending apertured fusible link 86 adjacent its outer end. A bolt 88, together with washer 90 and nut 92, serves to interconnect the lower end of link 86 with the flange 68 of handle 60.

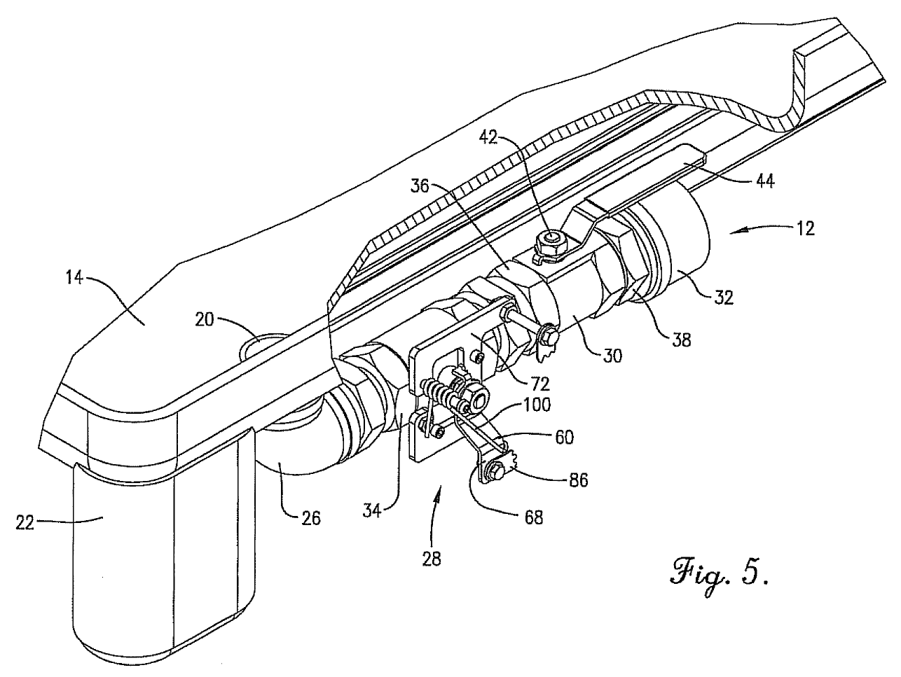

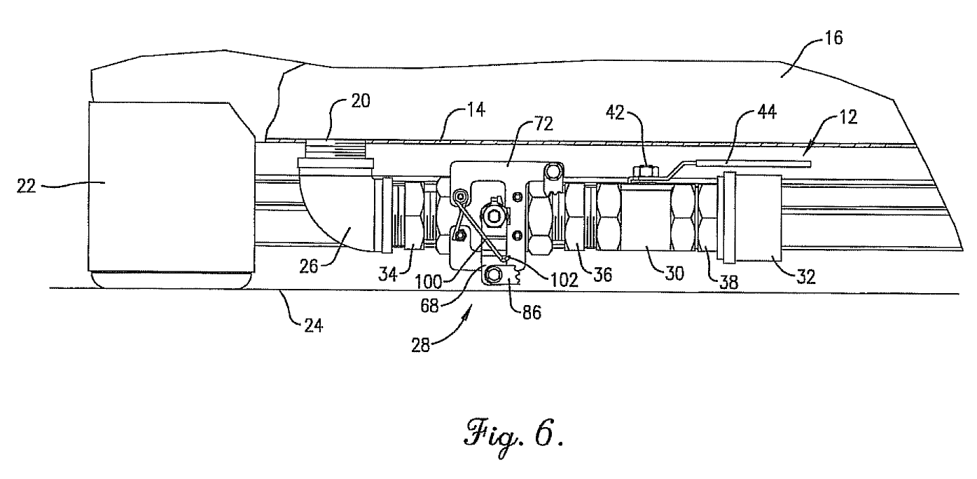

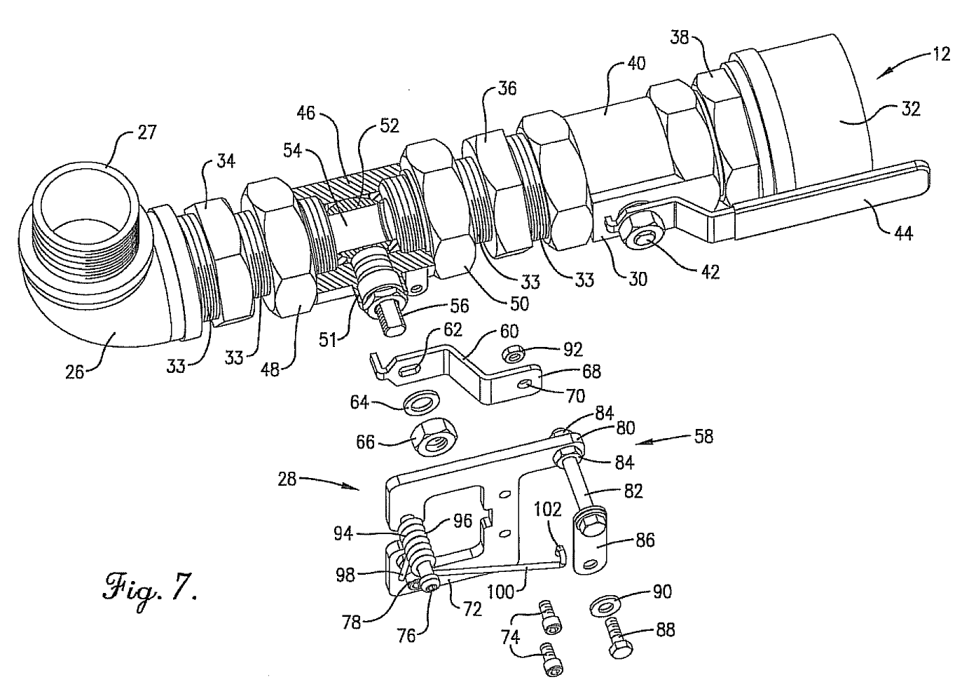

A coil spring 94 is supported on mount 76 and has a main coiled section 96 as well as legs 98 and 100. The leg 98 abuts the retainer 78 whereas leg 100 extends outwardly and engages the upper surface of flange 68. To this end, the outboard end of leg 100 has a U-shaped segment 102 which engages the flange 68 (see FIG. 4). The spring 94, when applied as illustrated, biases the handle 60 downwardly to the valve-closed position of emergency valve 28. However, during normal operation of assembly 12, valve-closing movement of the handle 60 is restrained by the link 86. However, upon fusing or severance of the link 86, the spring 94 comes into play and serves to rapidly close emergency valve 26 to the valve-closed position depicted in FIGS. 5 and 6.

The link 86 in preferred forms is designed to sever when it experiences elevated temperatures indicative of a fire adjacent container 10. For example, the illustrated link 86 is designed to melt at about 212° F. A variety of such temperature-responsive links are available, but preferred links of these types are available from GlobeTechnologies Corporation of Standish, Mich. If desired, however, links responsive to other emergency conditions such as fluid collection adjacent container 10, fluid spillage, or the presence of noxious gasses, could be employed in lieu of the preferred links.

It will be appreciated that the invention provides highly useful outlet valve assemblies specifically designed for intermediate bulk containers, in that the assemblies are of compact, robust construction, and can be supported beneath the bottom wall of 14 an IBC above the lower surfaces of the support legs 22. It thus differs from prior devices of this same general character which are not at all suitable for IBC use. In addition, while the preferred embodiment depicted in the Figures is an essentially straight-line design, the invention is not so limited. For example, arcuate or serpentine embodiments are within the scope of the invention, depending upon the nature of the IBCs to be protected. Also, the preferred embodiment has the emergency ball valve 28 upstream of the manually operable valve 30. This is not essential, and the order of the valves could be reversed if desired.

Another significant advantage of the valve assemblies and emergency ball valves hereof is the fact that they may be readily retrofitted onto existing IBCs without the need for any structural modifications of the IBCs. Indeed, attachment of the valve assemblies is a simple threaded attachment in lieu of existing manual valves.

I claim:

1. An outlet valve assembly designed for attachment to the outlet of an intermediate bulk container and comprising:
a manually operable valve shiftable between a valve-open position permitting flow of liquid therethrough and a valve-closed position preventing such liquid flow;
an emergency ball valve in series with said manually operable valve and having a rotatable valve ball with a fluid opening therethrough, and a valve stem coupled with the valve ball, said valve ball shiftable between a valve-open position permitting flow of liquid through said fluid opening, and a valve-closed position preventing such liquid flow; and
an emergency condition operator operably coupled with valve stem and operable to move said valve ball from the valve-open position to the valve-closed position in response to the occurrence of an emergency condition.

2. The assembly of claim 1, said manually operable valve being a ball valve.

3. The assembly of claim 1, said assembly including a tubular inlet designed for attachment to said intermediate bulk container outlet, and a tubular assembly outlet, said manually operable valve and said emergency ball valve located between said assembly inlet and said assembly outlet.

4. The assembly of claim 3, said emergency ball valve located upstream of said manually operable valve.

5. The assembly of claim 1, said emergency condition operator comprising:
a handle secured to said valve stem and operable to move said ball valve from said valve-open position to said valve-closed position thereof;
a spring operably engaging said handle and biasing the handle towards said valve-closed position thereof; and
a link coupled with said handle and operable to maintain the handle in said valve-open position thereof against the bias of said spring, said link operable to sever in the event of said emergency condition to permit said spring to move said ball valve from the valve-open position to the valve-closed position thereof.

6. The assembly of claim 5, said link operable to melt upon experiencing an elevated temperature consistent with a fire adjacent said container.

7. The assembly of claim 5, including a plate secured to said emergency ball valve, said plate supporting said spring and said link.

8. An intermediate bulk container comprising:
an upright tank having a bottom wall with a drain outlet opening therethrough, upstanding sidewall structure, and a plurality of legs secured to the underside of the tank and elevating said bottom wall above a support surface;
an outlet valve assembly attached to said drain outlet opening and located above said support surface, said outlet valve assembly comprising—
a manually operable valve shiftable between a valve-open position permitting flow of liquid therethrough and a valve-closed position preventing such liquid flow;
an emergency ball valve in series with said manually operable valve and having a rotatable valve ball with a fluid opening therethrough, and a valve stem coupled with the valve ball, said valve ball shiftable between a valve-open position permitting flow of liquid through said fluid opening, and a valve-closed position preventing such liquid flow; and
an emergency condition operator operably coupled with valve stem and operable to move said valve ball from the valve-open position to the valve-closed position in response to the occurrence of an emergency condition.

9. The container of claim 8, said manually operable valve being a ball valve.

10. The container of claim 8, said assembly including a tubular inlet designed for attachment to said intermediate bulk container outlet, and a tubular assembly outlet, said manually operable valve and said emergency ball valve located between said assembly inlet and said assembly outlet.

11. The container of claim 10, said emergency ball valve located upstream of said manually operable valve.

12. The container of claim 8, said emergency condition operator comprising:
a handle secured to said valve stem and operable to move said ball valve from said valve-open position to said valve-closed position thereof;
a spring operably engaging said handle and biasing the handle towards said valve-closed position thereof; and
a link coupled with said handle and operable to maintain the handle in said valve-open position thereof against the bias of said spring, said link operable to sever in the event of said emergency condition to permit said spring to move said ball valve from the valve-open position to the valve-closed position thereof.

13. The container of claim 12, said link operable to melt upon experiencing an elevated temperature consistent with a fire adjacent said container.

14. The container of claim 12, including a plate secured to said emergency ball valve, said plate supporting said spring and said link.

15. An emergency outlet valve comprising:
a valve body;
a rotatable valve ball within said body and having a fluid opening therethrough, and a valve stein coupled with said valve ball and extending out of said body, said valve ball shiftable between a valve-open position permitting flow of liquid through the outlet valve, and a valve-closed position preventing such liquid flow; and
an emergency condition operator operably coupled with valve stem and operable to move said valve ball from the valve-open position to the valve-closed position in response to the occurrence of an emergency condition.

16. The valve of claim 15, said emergency condition operator comprising:
a handle secured to said valve stem and operable to move said ball valve from said valve-open position to said valve-closed position thereof;
a spring operably engaging said handle and biasing the handle towards said valve-closed position thereof; and
a link coupled with said handle and operable to maintain the handle in said valve-open position thereof against the bias of said spring, said link operable to sever in the event of said emergency condition to permit said spring to move said ball valve from the valve-open position to the valve-closed position thereof.

17. The valve of claim 16, said link operable to melt upon experiencing an elevated temperature consistent with a fire adjacent said container.

18. The valve of claim 16, including a plate secured to said emergency ball valve, said plate supporting said spring and said link.
